(19) United States
(12) Patent Application Publication
(10) Pub. No.: US 2017/0024538 A1
(43) Pub. Date: Jan. 26, 2017

(54) SYSTEMS AND METHODS FOR PROMOTING PERSONAL HEALTH

(71) Applicant: HIGI SH LLC, Chicago (IL)

(72) Inventors: Khan SIDDIQUI, Hinsdale, IL (US); Jeff Bennett, Chicago, IL (US)

(21) Appl. No.: 15/100,242

(22) PCT Filed: Dec. 2, 2014
(86) PCT No.: PCT/US14/68189

§ 371 Date: May 27, 2016

Related U.S. Application Data
(60) Provisional application No. 61/910,885, filed on Dec. 2, 2013.

(51) Int. Cl. G06F 19/00; G06Q 50/00; G06Q 30/02; G06Q 10/10

(52) U.S. Cl. CPC G06F 19/3431; G06F 19/322; G06Q 10/105; G06Q 50/01; G06F 19/3481; G06F 19/3475; G06Q 30/0251

(57) ABSTRACT

Systems and methods for promoting personal health are provided. Sponsors of a health-related challenge program such as employees can set up goals, select participants, select duration and select prizes or rewards for the participants. The sponsors may also specify one or more acceptable user devices or tracking services that may be used by the participants of the program. The challenge programs may be individual or team based. Users of the present invention can enroll in the programs in any suitable fashion such as through a web interface and/or a health kiosk. A user may activate the enrollment at a health kiosk. The user may associate and/or dissociate tracking devices and/or services with a user account. Data collected at the health kiosk and/or from the associated tracking devices or services may be used to determine the performance of users or groups of users in the challenge programs.

### CROSS-REFERENCE

This application claims the benefit of U.S. Provisional Application No. 61/910,885, filed Dec. 2, 2013, which application is incorporated herein by reference.

### BACKGROUND OF THE INVENTION

Personal health can be improved with an active and healthy lifestyle that includes physical activities, healthy diet, social engagement, among others. However, people often lack the motivation to engage in such healthy activities or behaviors in a consistent fashion due to inconvenience, laziness, or other reasons. Therefore, there exists a need to effectively motivate people to participate in healthy activities or behaviors.

### SUMMARY OF THE INVENTION

Systems and methods for promoting personal health are provided herein. According to an aspect of the present invention, a computer-implemented method is provided. The method comprises collecting, by a health kiosk, health-related data from a user; determining, by a processor, a status of the user with respect to a challenge program based at least in part on the health-related data; and providing feedback information based at least in part on the determined status. The health-related data can include at least weight, blood pressure, pulse rate and body mass. The health-related data can be collected automatically by the health kiosk. The challenge program can be team-based. Determining the status can include determining a health score of the user based at least in part on physical data, lifestyle data and social data associated with the user. The social data can be obtained from one or more social media platforms. The feedback information can include at least one of reward information, personalized coaching information, or targeted advertisement.

According to another aspect of the present invention, a computer-implemented method is provided. The computer system comprises one or more processors; and a memory, including instructions executable by the one or more processors to cause the computer system to at least collect, by a health kiosk, health-related data from a plurality of users engaged in a challenge program; determine a status associated with the plurality of the users with respect to the challenge program based at least in part on the health-related data; and provide feedback information to at least some of the plurality of users based at least in part on the determined status. The status can be further based on additional health-related data provided by user devices associated with at least a subset of the plurality of users. Determining the status can include determining an overall score based at least in part on physical data, lifestyle data and social data associated with the plurality of users.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 illustrates an exemplary system for implementing the present invention, in accordance with an embodiment.

FIG. 2 illustrates an exemplary computing device for implementing aspects of the present invention, in accordance with an embodiment.

FIG. 3 illustrates an exemplary health kiosk for collecting health data of a person, in accordance with an embodiment.

FIG. 4 illustrates an exemplary process for implementing aspects of the present invention, in accordance with an embodiment.

FIG. 5 illustrates an exemplary process for using the present invention, in accordance with an embodiment.

FIG. 6 illustrates an exemplary process for collecting health related data, in accordance with an embodiment.

FIG. 7 illustrates an exemplary process for a setting up a challenge program, in accordance with an embodiment.

### DETAILED DESCRIPTION OF THE INVENTION

The present invention provides systems and methods for promoting personal health by encouraging users to engage in health-related challenges involving rewards and prizes. In some embodiments, sponsors of a challenge program such as employees can set up a goal, select participants, select a duration and select one or more prizes or rewards for the participants. The sponsors may also specify one or more acceptable user devices or tracking services that may be used by the participants of the program. The challenge programs may be individual or team based. Users of the present invention can enroll in the programs in any suitable fashion such as through a web interface and/or a health kiosk. A user may activate the enrollment at a health kiosk. The user may associate and/or dissociate tracking devices and/or services with a user account. Data collected at the health kiosk and/or from the associated tracking devices or services may be used to determine the performance of users or groups of users in the challenge programs.

The present invention combines the consumer-centric health engagement tools (e.g., health kiosks, tracking devices and apps) with challenge/reward programs in order to engage users to earn rewards for exercising. User data from various devices are aggregated to allow users to compete against each other for sponsored prizes while also driving them to retail locations with health kiosks which provide accurate base vitals (blood pressure, pulse, weight, BMI, and the like) in a minimally invasive manner.

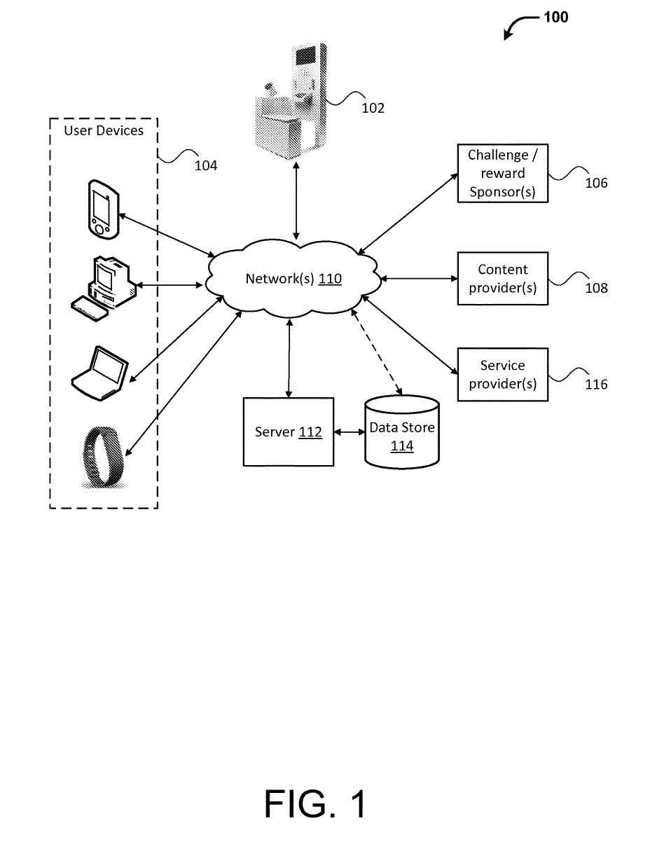

FIG. 1 illustrates an exemplary system 100 for implementing the present invention, in accordance with an embodiment. The system 100 may be used to promote personal health or healthy lifestyles and behaviors of people. In particular, the system can be configured to provide health-related challenge or reward programs, collect and track health related data from one or more participants of the programs, determine rewards and/or prizes for participants of the programs, and the like.

As illustrated, one or more health kiosks 102 can be connected to the each other and/or a server 112 via one or more networks 110 to utilize the challenge-related features described herein. The health kiosks may be configured to collect and/or calculate a user's health data such as weight, blood pressure, heart rate, body mass index, fat mass, pulse, blood glucose, and the like. Such health data may be collected automatically via one or more health data collection devices and/or input manually by users via a user interface. For example, the health kiosks may be used by users to input information such as age, height, gender, race, lifestyle information, health history information, and the like. The health kiosks can also be configured to transmit the collected user health data to and/or receive information from a remote entity such as a remote server 112. In some embodiments, the health kiosks can be configured to receive user input as well as providing feedback information related to a user's health such as collected health data, trend analysis, participation in a reward/challenge program, personalized or general coaching advice or tips, articles, and the like. In various embodiments, the health kiosks may be configured to perform a variety of other functionalities such as sample analysis, user authentication, biometric identification (e.g., via facial characteristics, retina, finger prints), printing, saving and/or sharing of health related data, and the like.

As illustrated, one or more user devices 104, operated by or otherwise associated with users, may also be connected to the server 112 via the one or more networks 110 to utilize the challenge-related features described herein. In various embodiments, the user devices 104 may include any devices capable of communicating with the server 112, such as personal computers, workstations, laptops, smartphones, mobile phones, tablet computing devices, smart TV, game consoles, smart appliances, and the like. The user devices 104 may also include wearable devices configured to capture the wearer's physical data such pedometers, wristbands, heart rate monitors, augmented (e.g., sensor-embedded) clothing, watches, glasses, helmets, shoes, and the like. In some embodiments, the user devices 104 may be capable of communicating directly with the server 112, for example, via an interface provided by the server 112. Such an interface may include an application programming interface (API) such as a web service interface, a graphical user interface (GUI), and the like. Alternatively or additionally, the user devices 104 may be capable for communicating with other user devices. For example, a pedometer may be capable of communicating with another user device (e.g., a smartphone or computer) via wired (e.g., via a USB cable) or wireless (e.g., via radio frequency) communication methods. In various embodiments, the user devices may be configured to collect and transmit health related data to the server and/or provide access to information obtained from the server such as additional user data, trend/historical analysis (e.g., charts, diagrams), challenge/reward information and the like.

In some embodiments, the user devices 104 may be include applications for monitoring or tracking a user's physical activities and/or biometrics data automatically via sensors and/or manually via user input interfaces. Such sensors may include GPS receivers, inertial sensors (e.g., gyroscopes and/or accelerometers), visual sensors (e.g., camera), proximity sensors, temperature sensors, touch sensors, and the like. In addition, the user devices 104 may be used to track or monitor users' biometric data. For example, the user devices may include blood pressure monitor, weighting scale, sleep monitor, glucose monitor, and the like. In some embodiments, some of the sensors provided by the user devices 104 (e.g., pulse sensor) may be similar to or different from the health data collection devices used by the health kiosks.

In some embodiments, a personalized health score for a user may be provided based on health related data such as biometric data, lifestyle information, and community information. In some embodiments, the health score include a number (e.g., between 1 and 999, or between 0 and 1) and/or a non-numeric value. The health score may be generated by an algorithm that takes into account the user's body statistics, social engagement, personal interactions, and/or other factors. In some embodiments, users can engage with their health scores as well as other wellness-related content at health kiosks, via mobile apps, web interfaces, or the like.

In some embodiments, lifestyle information may include choices users make such as address, physical activity, dietary or nutritional information (e.g., food or calories consumed or to be consumed), quality and/or number of sleep, smoking or drinking habits, or any other factors that can have a bearing on the quality of life.

Community information may include the characteristics of social relationships such as with friends, family, colleagues, and the like. The characteristics may include scope, strength, and duration of such relationships. In some embodiments, such characteristics may be gleaned from content data and/or user data obtained from a variety of social media platforms. The content may include blogs, microblogs, tweets, posts, comments, and the like. The user data may include friends lists, lists of followed or following users, and the like. Examples of the social media platforms can include Facebook, provided by Facebook, Inc. of Menlo Park, Calif.; Twitter, provided by Twitter, Inc. of San Francisco, Calif.; Google+, provided by Google, Inc. of Mountain View, Calif.; Reddit, provided by Reddit, Inc. of San Francisco, Calif.; Tumblr, provided by Tumblr, Inc. of New York, N.Y.; LinkedIn, provided by LinkedIn Corporation of Mountain View, Calif.; Foursquare, provided by Foursquare Labs, Inc. of New York, N.Y.; Instagram, provided by Facebook, Inc. of Menlo Park, Calif.; Youtube, provided by Google, Inc. of Mountain View, Calif.; Blogger, provided by Google, Inc. of Mountain View, Calif.; WeChat, provided by Tencent Holdings Limited of Guangdong, China, and the like. In various embodiments, the social media platforms may implement APIs for providing access to social data contained therein. In some embodiments, the social media platforms can include a community comprising participants in the reward/challenge programs described herein. In such communities, participants can provide, receive and share health related information, interact with other users, and the like.

The server 112 may be configured to receive or obtain data from a variety of sources such as user devices 104, health kiosks 102, service providers 116 and content providers 108. The service providers 116 may provide individualized or aggregate health or health related data that may be useful for determining the health or wellbeing of individuals or groups of individuals. For example, data from such service providers may be used to determine the health score discussed herein. In some embodiments, service providers 116 may include social media service providers such as discussed above. Service providers 116 may also include healthcare providers such as hospitals and practitioners or health related service providers such as gyms, yoga studios, and the like. The health related data provided by such service providers may include patient records, test results, workout information, and the like. In typical embodiments, some or all of such health related data (such as the personally identifying information) from some or all of the sources discussed above may be encrypted, obscured, removed, desensitized, otherwise processed before being provided to the server 112 to protect the privacy of people involved. In some embodiments, such data processing may be performed by the server 112. In some embodiments, the service providers may include retailers, hotels, travel services such as airlines, and the like. Data provided by such service providers may include individual or aggregate behavioral data (e.g., favorite restaurants or menu selections, hotel checkins, average length of vacation time), lifestyle data, social data, and the like.

In some embodiments, the service providers 116 include location, activity or fitness tracking services. Some of such services may be implemented as mobile applications (apps) running on user devices and/or server applications accessible via user interfaces such as websites, web services, and the like. Examples of such tracking services can include RunKeeper, Endomondo, Fitbit, BodyMedia, Nike+, Foursquare, MapMyFitness, Omron, Moves, Garmin, EveryTrail, and the like. In some embodiments, users may be allowed to select and link accounts with these tracking services so as to utilize the data maintained by such services, for example, for use in the participated reward or challenge programs.

In some embodiments, the content providers 108 can include advertisers or retailers. Data provided by such content providers may include advertisement for products or services. The content providers 108 can also include content publishers such as newspapers, magazines, and government agencies. In various embodiments, the content provided by the content providers may or may not be personalized or targeted to an individual or a group of individuals. In some embodiments, the content data may be provided based at least in part on user profile data, user preferences, and/or health related data. In some embodiments, the content data may also be provided based at least in part on the various aspects or characteristics associated with the content providers. In various embodiments, the content data may be provided to the users using a push technology, pull technology or a combination of both.

As illustrated, one or more challenge or reward sponsors 106 may also communicate with the server 112 via the network(s) 110. In various embodiments, users of the present invention may elect to participate in one or more reward or challenge programs to compete against other users or groups of users for rewards such as prizes, points, coupons, products or services, and the like. The challenge or reward sponsors may include any public or private entities that provide the rewards or incentives for people to participate in such rewards or challenges. Examples of such sponsors may include retail brands, companies, schools, city, state or federal governments, non-profit or for-profit organizations, and individual or groups of individuals (e.g., a family), and the like. In some embodiments, the server 112 can communicate with reward or challenge sponsors 106, for example, to obtain reward or challenge rules, validate or redeem rewards and the like.

In some embodiments, the server 112 may be implemented by one or more physical and/or logical centralized or distributed computing devices or computer systems that collectively provide the functionalities of a health challenge service described herein. For example, the server 112 may be configured to receive health related data from one or more health kiosks 102, user devices 104, or service providers 116 such as described herein. The server 112 can also be configured to receive content data such as advertisement or articles from content providers 108. In addition, the server 112 can be configured to accumulate, monitor and track health related data and/or participation in reward or challenge programs for individuals or groups of individuals such as a team, a company, a neighborhood, a school, a city, and the like.

In some embodiments, the server 112 may also provide personalized feedback or content to users. Such feedback may allow users to gain insights into various aspects of their health, lifestyle, social support structure, or other aspects of their lives. For example, the feedback may include charts or diagrams showing health or fitness metrics of a user over time. In some embodiments, the feedback can also include information about a user or a group of users' participation in rewards or challenge programs. For example, the feedback may allow a user to see his or her progress towards a challenge, standing as compared to other participants of the challenge, reward points gained and/or redeemed, and the like.

In some embodiments, the feedback may be provided in real time or near real time fashion as data is being updated. In other embodiments, the feedback may be provided on a periodic basis (e.g., hourly, daily, weekly, monthly). In yet other embodiments, the feedback may be provided only when triggered by certain events such as user requests, completion of milestones, and the like. Push, pull or a combination of both technologies may be used to provide the feedback.

In an embodiment, the server 112 comprises a frontend (not shown) for handling requests from various clients of the system and a backend (not shown) for retrieving, storing and/or processing data. In some embodiments, the frontend may include client applications (e.g., mobile apps) running on user devices. The frontend may also include web services, web portals or other user interfaces. The backend may be configured to implement the aspects of the various functionalities or methods described herein.

In some embodiments, the server 112 may comprise one or more computing services provisioned from a “cloud computing” provider, for example, Amazon Elastic Compute Cloud (“Amazon EC2”), provided by Amazon.com, Inc. of Seattle, Wash.; Sun Cloud Compute Utility, provided by Sun Microsystems, Inc. of Santa Clara, Calif.; Windows Azure, provided by Microsoft Corporation of Redmond, Wash., and the like.

In some embodiments, the server 112 communicates with a data store 114 to retrieve and/or store data used by the health challenge service. For example, such data may include demographic information, health related data, social data, feedback information, reward/challenge information, advertisement data and/or data derived thereof.

In some embodiments, the data store 114, or any other data stores discussed herein, may include one or more centralized or distributed databases (e.g., SQL database), data storage devices (e.g., tape, hard disk, solid-state drive), data storage servers, and the like. In various embodiments, such a data store 114 may be connected to the server 112 locally or remotely via a network. In some embodiments, data store 114, or any other data stores discussed herein, may comprise one or more storage services provisioned from a “cloud storage” provider, for example, Amazon Simple Storage Service (“Amazon S3”), provided by Amazon.com, Inc. of Seattle, Wash., Google Cloud Storage, provided by Google, Inc. of Mountain View, Calif., and the like.

In various embodiments, network 110 may include the Internet, a local area network (“LAN”), a wide area network (“WAN”), a cellular data network, a wireless network or any other public or private data network.

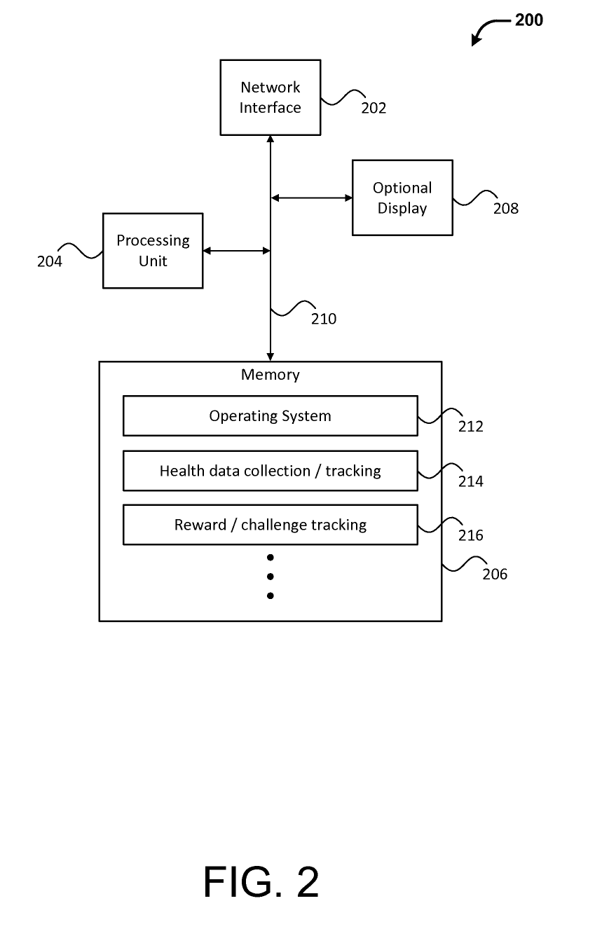

FIG. 2 illustrates an exemplary computing device 200 for implementing aspects of the present invention, in accordance with an embodiment. In an embodiment, the computer device 200 may be configured to implement user devices 104 and/or components or the server 112 such as described in connection with FIG. 1. In some embodiments, computing device 200 may include many more components than those shown in FIG. 2. However, it is not necessary that all of these components be shown in order to disclose an illustrative embodiment.

As shown in FIG. 2, computing device 200 includes a network interface 202 for connecting to a network such as discussed above. In various embodiments, the computing device 200 may include one or more network interfaces 202 for communicating with one or more types of networks such as the Internet, wireless networks, cellular networks, and any other network.

In an embodiment, computing device 200 also includes one or more processing units 204, a memory 206, and an optional display 208, all interconnected along with the network interface 202 via a bus 210. The processing unit(s) 204 may be capable of executing one or more methods or routines stored in the memory 206. The display 208 may be configured to provide a graphical user interface to a user operating the computing device 200 for receiving user input, displaying output, and/or executing applications. In some cases, such as when the computing device 200 is a server, the display 208 may be optional.

In some embodiments, the memory 206 can include a non-transitory computer readable medium or transitory computer readable medium. For example, the memory 206 can include random access memory (“RAM”), read only memory (“ROM”), disk drive, floppy disc, tape, DVD/CD-ROM drive, memory card, USB flash drive, solid state drive (SSD) or the like. The memory 206 can be configured to store data received from the processing unit 204, an input device (not shown), or other modules of the computing device. The memory 206 may also store program code or program instructions executable by the processing unit to perform any suitable embodiments of the methods described herein. For example, the program code can include an operating system 212, a health data collection/analysis routine 214, a reward/challenge tracking routine 216, and the like. In some embodiments, program code may be located into the memory 206 using a drive mechanism associated with a non-transient computer readable storage medium such as discussed above. In other embodiments, the program code may alternatively be loaded via the network interface 202, rather than via a non-transient computer readable storage medium.

In some embodiments, the computing device 200 also communicates via bus 210 with one or more local or remote databases or data stores such as an online data storage system via the bus 210 or the network interface 202. The bus 210 may comprise a storage area network (“SAN”), a high-speed serial bus, and/or via other suitable communication technology. In some embodiments, such databases or data stores may be integrated as part of the computing device 200.

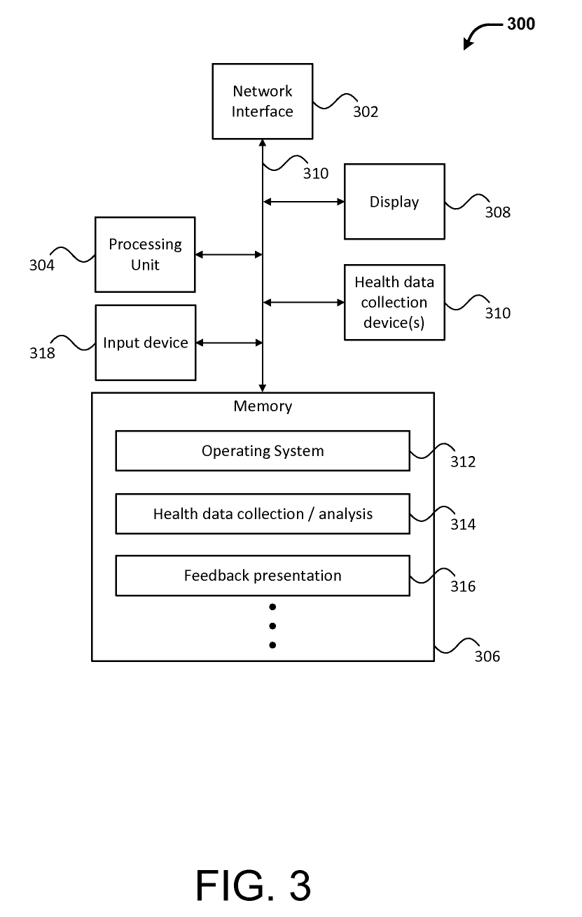

FIG. 3 illustrates an exemplary health kiosk 300 for collecting health data of a person, in accordance with an embodiment. Some components of the health kiosk 300 may be similar to those of the computing devices 200 discussed in connection with FIG. 2. For example, the health kiosk 300 may include one or more network interfaces 302 for communicating with one or more types of networks such as the Internet, wireless networks, cellular networks, and any other network. In some embodiments, the health kiosks may not be network enabled. The health kiosk 300 can also include one or more processing units 304, a memory 306, and a display 308, all interconnected along with the network interface 302 via a bus 310. In some embodiments, the hardware or software of the health kiosk may be specialized.

The memory 306 may include transitory or non-transitory computer readable storage medium. The memory 306 can be configured to store data received from the processing unit 304, one or more input devices 318, one or more health data collection devices 310, and/or other modules of the computing device. The memory 306 may also store program code or program instructions executable by the processing unit to perform any suitable embodiments of the methods described herein. For example, the program code can include an operating system 312, a health data collection/analysis routine 314, a feedback presentation routine 316, and the like.

The health kiosk can include one or more input devices 318, for example, for entering user information. Such input devices 318 may include keyboard, mouse, joystick, touch screen, microphone, camera, image scanner, radio frequency (RF) identification reader, and the like. In some embodiments, the input devices 318 may be configured to recognize visual or audio commands, gestures or body movement. In some embodiments, the input devices 318 can be configured to capture physiological or behavioral characteristics of an individual for identification and/or authentication purposes. Such characteristics can include fingerprints, palm print, face recognition, iris recognition, typing rhythm, voice, and the like.

To collect health data for an individual, the health data collection devices 310 can include one or more health data collection devices 310 capable of collecting physical characteristics of an individual user. Examples of such health data collection devices 310 can include a weight sensor (e.g., scale), blood pressure sensor (e.g., pneumatic blood pressure cuff assembly), heart rate monitor, temperature sensor, breath analyzer, oximeter, body fat analyzer, blood glucose analyzer, organic compound receiver/analyzer, and the like.

In some embodiments, the health kiosk 300 may be configured to interface with one or more user devices such as smartphones, fitness tracking devices, laptops and the like and/or storage devices such as CDs, DVDs, USB sticks, and the like, to obtain data from and/or to output data to such user devices. In some embodiments, the health kiosks 300 may also be used to interface with one or more tracking services discussed in connection with FIG. 1.

In some embodiments, data collected via the health data collection devices 310 and/or input devices 318 stored and/or analyzed locally by the health data collection device. Additionally or alternatively, the data may be transmitted and/or stored at a remote location such as a remote server such as server 112 discussed in connection with FIG. 1.

In some embodiments, the health kiosks can be located at locations easily accessible to participants or potential participants of the reward or challenge programs. For example, the health kiosks can be located at retail or grocery stores, pharmacies, gyms, school campuses, office buildings, and the like.

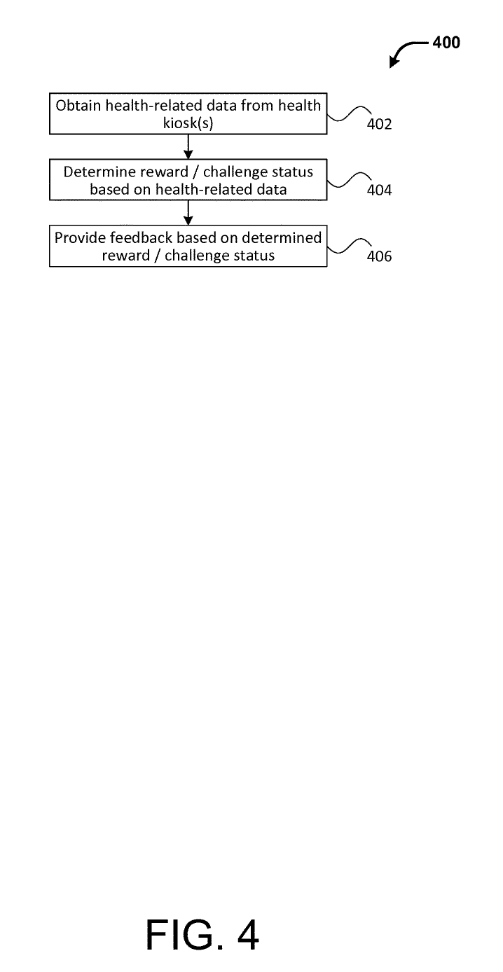

FIG. 4 illustrates an exemplary process 400 for implementing aspects of the present invention, in accordance with an embodiment. Aspects of the process 400 may be performed by the server 112, user devices 104, or health kiosks 102 discussed in connection with FIGS. 1-3, or any combination thereof. Some or all aspects of the process 400 (or any other processes described herein, or variations and/or combinations thereof) may be performed under the control of one or more computer/control systems configured with executable instructions and may be implemented as code (e.g., executable instructions, one or more computer programs or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory. The order in which the operations are described is not intended to be construed as a limitation, and any number of the described operations may be combined in any order and/or in parallel to implement the processes.

In some embodiments, process 400 includes obtaining 402 health related data from one or more health kiosks such as those described in connection with FIGS. 1 and 3. In some embodiments, a user may engage with a health kiosk by logging in the user's account with user credentials (e.g., username and password) and/or biometrics information. In other embodiments, the user may engage with a health kiosk without being required to log in. Typically, only one user can use a health kiosk at a time. In some embodiments, the health kiosk may support simultaneous use by multiple users.

Once engaged with the user, the health kiosk may present, via a user interface, a plurality of options for the user to choose from. For example, the user may choose to measure the current health data. The user may also be able to select a subset of all available measurements. In response to such user selection, the health kiosk may proceed to acquire the user's current health related data via one or more health data collection devices such as described in connection with FIG. 3. In some cases, the health related data may be collected automatically without any user intervention or with minimal invasiveness. In other cases, the collection process may be more involved. In some embodiments, the health-related data may be collected via input devices such as described in connection with FIG. 3. For example, the user may input basic user information such as age and gender via input devices associated with the health kiosk. As another example, the health kiosk may obtain (via a wired or wireless communication medium) health related data such as fitness tracking data from one or more user devices such as described in connection with FIG. 1. In various embodiments, the health related data collected by the health kiosks and/or the user devices may include user's weight, height, blood pressure, pulse rate, body fat, blood oxygen, glucose, cholesterol, low-density lipoprotein (LDL), high-density lipoprotein (HDL), hemoglobin A1C, and the like. Preferably, the data is collected in a non-invasive or minimally-invasive manner. The currently collected health related data may be stored in local and/or remote data stores. In some embodiments, the currently collected health related data is provided to the user in real time or near real time as the results become available. In other embodiments, the results may be provided after a longer period of time or via other another communication medium.

Alternatively or additionally, the user may choose to view the user's previously collected health data. In some embodiments, the previously collected data may be retrieved from a remote location such as the server 112 discussed in connection with FIG. 1 and/or from a storage local to the health kiosk. For example, in some embodiments, a health kiosk may store locally health data associated with a plurality of users (e.g., students in a particular dormitory or residents of a particular neighborhood).

Based at least in part on the health related data collected at health kiosks, a user's health information may be updated, for example, at the server 112 discussed in connection with FIG. 1. In some embodiments, the health related data collected at health kiosks are merely used to activate enrollment in reward/challenge programs and/or to provide insight into impact of fitness activities or behaviors tracked by tracking devices or services. In some embodiments, health-related data obtained from sources other than health kiosks may also be used or otherwise combined with the kiosk-obtained data to update the user's current health information.

In some embodiments, social data such as from a user's social media platforms may be searched or otherwise processed to obtain data relevant to the user's physical or mental health. For example, the amount and/or types of activities on a social platform over a given period of time may be indicative of a user's level of social engagement or activeness. For example, a high level of comments or posts on Facebook or a large number of new connections on LinkedIn by the user over a short period of time may indicate a high level of social engagement for the user. In some embodiments, the social data related to the user such as people's response to the user's comments or posts may indicate the quality or strength of the user's social connections. Such social aspects of a user's life can be captured and used in determining the overall wellbeing of the user. Alternatively or additionally, other factors such as lifestyle data obtained from surveys and/or social media platforms may also be used.

In an embodiment, the process 400 includes determining 404 a status for a participant with respect to a reward or challenge program based at least in part on the health related data that may or may not be based on data collected at health kiosks. As discussed above, a user or a group of users (e.g., a team) may elect to participate in one or more rewards or challenge programs. Such programs may incentivize participants to achieve certain health-related goals or compete with each other in health-related activities, behaviors or biometrics in exchange for prizes and rewards. As used herein, a participant can refer to an individual or a group of individuals. Hence, the health-related data used for reward or challenge purposes can refer to data for a specific individual or the aggregate data for a group of individuals. For example, the status can include points or score of an individual, total points or score of a team, or average points or score of a team. In an embodiment, the reward/challenge programs can be sponsored by corporations to encourage healthy behaviors for their workforce. In another embodiment, the reward/challenge programs can be sponsored by retail brands or stores to increase their visibility or profitability. In yet another embodiment, the reward/challenge program can be created by a user or a group of users. In various embodiments, the rewards can be tangible (e.g., certificate, coupons, cash, products) or intangible (e.g., redeemably reward points, discount, services). For example, in an embodiment, users can win prizes by earning points based off of the data produced from their daily activity tracker. Points can be redeemed for sponsored rewards in the marketplace on a certain website, at a retail store, gym, healthcare facility, or the like. Challenge sponsors—brands, companies and retailers—can promote their brand and products as rewards for users

Still referring to FIG. 4, in an embodiment, determining 404 the status of a participant of a reward/challenge program includes determining whether and/or the extent to which certain milestones have been reached according to the rules associated with the reward/challenge program. For example, the program may have a duration (e.g., a start and/or end date), a set of rules or metrics used to determine results or performance of the participants of the program, and rewards or prizes. In some embodiments, the rules, criteria or metrics may be specified in terms of physical activities (e.g., calories burned, miles run, etc.), health metrics (e.g., improvement of biometric data such as improving or maintaining weight, blood pressure, or the like), lifestyle indicators (e.g., reduced smoking, healthier food consumption), social wellbeing (e.g., number of new friends or connections), participation (e.g., periodic checkins at a health kiosk and/or via user devices), and the like, or any combination thereof. In various embodiments, the status of a participant (e.g., a user or a group of user) can include a comprehensive health score calculated for the participant based at least in part on the above discussed factors, an indication of progress toward a set goal (e.g., percentage of score achieved or number of calories burned), ranking of the participant relative to other participants, current reward points collected, or the like. In some embodiments, determining the status may involve aggregating health data from a plurality of users, for example, to calculate the total or average points for a team comprising the plurality of users. In various embodiments, the determining of the status may be performed in real time or nearly real time as the user data is updated, in a batch process and/or on a periodic basis.

In some embodiments, determining reward/challenge status may include automatically identifying one or more winners for the corresponding reward/challenge program based on predetermined rules or criteria. Such rules or criteria may be set by sponsors of the programs (e.g., employers). In some embodiments, the winners may be selected randomly from a pool of users that satisfy the predetermined criteria.

In some embodiments, the process 400 includes providing 406 feedback information to the participant. The feedback information may be based at least in part on the determined reward/challenge status described above. In various embodiments, the content of the feedback information may include any of the status information discussed above. Alternatively or additionally, the feedback information can include personalized coaching or advice, tips, articles, targeted advertisement, or the like. In various embodiments, the feedback information can be provided in textual or pictorial format, audio or visual format, multi-media format or any other suitable format. The feedback information can be provided in electronic format or non-electronic format (e.g., paper coupon). Further, the feedback information can be delivered in real or nearly real time, at predetermined times and/or on a periodic basis. Push, pull or a combination of both technologies can be used for the delivery of the feedback information. In addition, the feedback information may be accessed from a variety of different devices such as the health kiosks, and user devices.

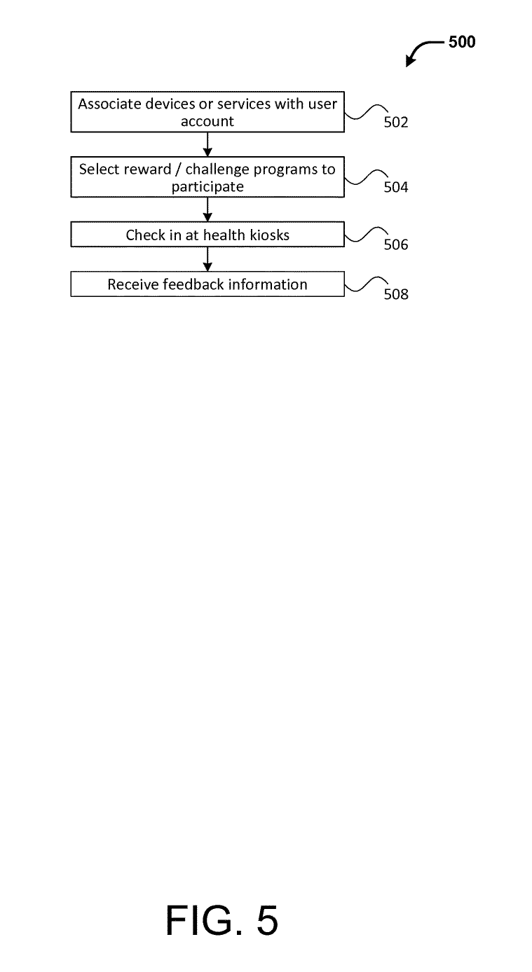

FIG. 5 illustrates an exemplary process 500 for using the present invention, in accordance with an embodiment. The process 500 may be performed by participants (user or group of users) of reward/challenge programs using a user device, health kiosk or a combination thereof.

In an embodiment, the process 500 includes associating 502 one or more devices or services with a user account. The devices and services can include those discussed in connection with FIG. 1. For example, the devices can include pedometers, GPS-enabled tracking devices, fitness tracking devices, and the like. The services can include RunKeeper, Endomondo, Fitbit, BodyMedia, Nike+, Foursquare, MapMyFitness, Omron, Moves, Garmin, EveryTrail, and the like. Such association can provide access to health related data maintained or monitored by such devices and services so that the data can be used for reward or challenge programs. In order to associate the selected devices and/or services, users may be required to provide respective credentials (e.g., account id and password) for the associated devices and/or services. Alternatively or additionally, the devices or services may become associated automatically or semi-automatically. For example, devices with a certain range may be automatically detected and associated with the user account based on a proximity based wireless technology (e.g., Bluetooth).

In some embodiments, the users may also be allowed to dissociate existing devices or services with a user account. In various embodiments, such associations or dissociations can be performed using a user interface provided by the health kiosks, user devices, or a web portal. In some embodiments, the association of devices or services may be optional.

In an embodiment, the process 500 includes selecting, by a participant, one or more reward programs to participate in. In some embodiments, a plurality of available or recommended programs may be provided to a user. The available or recommended programs may be provided and/or sorted based on start date and/or end date of the programs, subject matter, location, relevancy to the user, sponsors and the like. It is appreciated that the order of steps 502 and 504 may be reversed. That is, users may enroll in reward or challenge programs before selecting devices or services to be associated with the programs. In some embodiments, the types or numbers of associated devices or services may be constrained by the rules of the corresponding reward or challenge programs. In some embodiments, a user or a group of users can create such reward or challenge programs. In some embodiments, a user can invite other people to join the programs.

In an embodiment, the process 500 includes checking in 506 at health kiosks. Such checkins may be used to collect the current health related data, assess the impact of fitness activities such as tracked by other user devices, and/or determine status with respect to a reward or challenge program. In some embodiments, the health data collected from such checkins may be used as factors in the reward/challenge programs. In some other embodiments, the health data collected from such checkins are not factored in the evaluation of the reward/challenge programs. In such embodiments, the checkins may be used purely as supplemental information to show the impact of the users' diet, physical activities or behaviors on his or her health. In yet some other embodiments, the checkins themselves and not the health data collected from such checkins, may be used as factors for the evaluation of the reward/challenge programs. For example, a reward/challenge program may require a completion of at least three health kiosk checkins per month. In some embodiments, the health kiosks may be used for activating enrollment in a reward/challenge program. For example, an employee can enroll in an employer sponsored challenge on a website and activate the enrollment at a health kiosk.

At health kiosk checkins, users may receive 508 feedback information such as reward information, personalized coaching or advice, tips, articles, targeted advertisement, or the like, such as described in connection with step 406 of process 400 discussed in connection with FIG. 4. The user may then redeem rewards, if any, subject to any predetermined rules associated with the reward/challenge programs. Such feedback information may or may not be based on the health related data collected at the health kiosks.

In various embodiments, the user may be allowed to perform a variety of other operations at the health kiosks or using a user interface (e.g., web portal, mobile apps) provided by the health challenge service described herein. For example, the users can save or share their health information and/or challenge/reward information with friends, family, colleagues, acquaintances, or any other suitable person or entities via email, text message, social media platforms, and the like. As another example, users may be allowed to schedule periodic and/or event driven reminders or notifications such as expiration of reward/challenge programs or reward points, recommended reward/challenge programs, achievement of major milestones, status of other users. In some embodiments, users may be allowed to follow the status of other users.

In some embodiments, a user (e.g., an employee) can participate in a challenge program (e.g., employer-sponsored wellness program) by enrolling in the program via a web interface. For example, the user may point his browser to “http://higi.com/yourcompany”, where yourcompany is the name of the employer sponsor. The web interface may allow the user to sign up or register for an existing challenge program. The registration process may include the user entering user information such as demographic information and preferences. The user may have the option to choose from a list of existing challenge program. The list of available challenge program for a particular user may be customized based on user-specific information such as the user's employer, geographic location, sex, age, education, ethnicity, interests, preferences, health or lifestyle information, and the like. For example, employees of a particular company may select a challenge sponsored by this company.

The web interface may also provide the options for the user to select a team to join, create a team, or join a challenge program as an individual user. For example, the web interface may present one or more existing teams for the user to join. The available teams for a particular user may be customized based on user-specific information such as the user's employer, geographic location, sex, age, education, ethnicity, interests, preferences, health or lifestyle information, and the like. The user may also be allowed to create and join a brand new team. The user may be allowed to send invitations to other users to join the newly created team (e.g., via e-mail messages, text messages, social networks, etc.).

The web interface may also allow the user to associate or link one or more accounts associated with health-related services with the challenge program. The health-related services may include health or fitness services or location-based services such as Nike+, EveryTrail, RunKeeper, Fitbit, Garmin, Foursquare, Endomondo, Mapmyfitness, Bodymedia Fit, and the like. By linking user's accounts for these services with the challenge program, user data from these services can be used in the challenge program in various ways such as for earning points or rewards, competing with other teams, and the like.

After signing up or registering for a challenge program, the user may activate the challenge by checking in at a health kiosk. In some embodiments, the kiosk checkin may be required for completing the user's enrollment in the challenge program. In other embodiment, the kiosk checkin may be optional. In some cases, the kiosk checkins may be used to earn points or reward for a challenge program.

The user may check the ongoing status of the challenge program by going to the web interface discussed above, using applications on user devices, via an interface at a health kiosk, or through notifications such as via email or text messages, phone calls, and the like. The status may include a standing or ranking of the user or the user's team relative to other users or other teams. The status may also include current reward points or levels of the user, other users, the user's team, or other teams. As such, the challenge programs are likely to incentivize users to engage in healthy competitions to promote personal health.

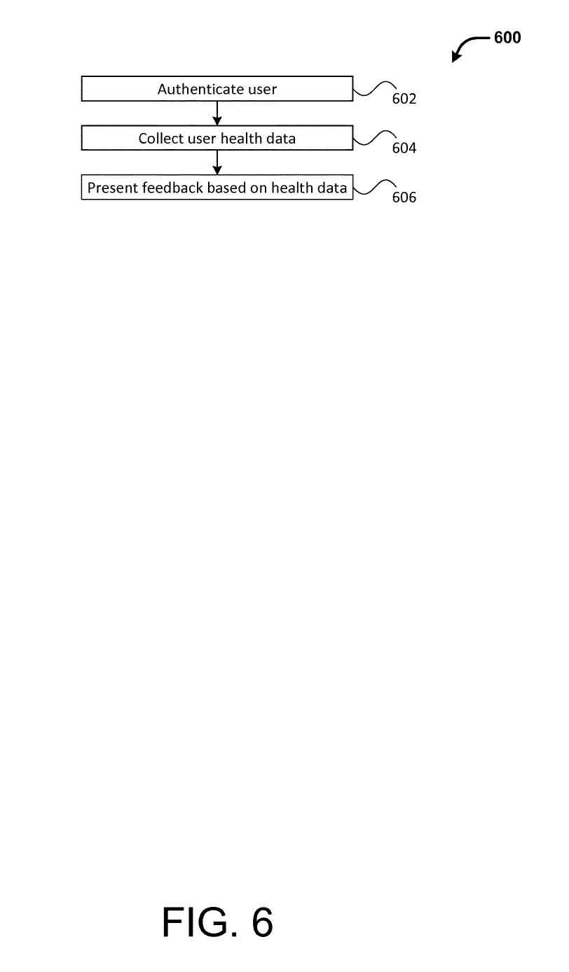

FIG. 6 illustrates an exemplary process 600 for collecting health related data, in accordance with an embodiment. The process 600 may be implemented by a health kiosk such as described in connection with FIGS. 1 and 3.

In an embodiment, the process 600 includes authenticating 602 a given user. Various authentication schemes may be used. For example, the authentication may include validating a pair of user provided account name and password, answers to security questions, biometric information (e.g., fingerprints, facial or iris recognition). In some embodiments, such authentication can involve communication with one or more remote authentication servers.

In an embodiment, the process 600 includes collecting 604 user health data such as using one or more health data collection devices and/or one or more input devices associated with the health kiosk such as discussed in connection with FIG. 3. The collected data may be transmitted to a remote server for storage and/or processing. In some embodiments, collected data may be processed and/or stored locally at the health kiosk prior to and/or after being transmitted to the remote server.

In an embodiment, the process 600 includes presenting 606 feedback information based at least in part on the health data. For example, the currently measured health data may be presented to the user via a user interface provided by the health kiosk. The feedback information may also include status information with respect to one or more reward or challenge programs that the user participates in. For example, the health kiosk may be configured to print coupons or reward certificates as reward from such programs. Further, the feedback information may include historical data, trend analysis, targeted advertisement, personalized coaching, tips or articles and the like. At least some of the above information may be obtained from a remote server such as the server 112 discussed in connection with FIG. 1. In alternative embodiments, the feedback information may be based on health data obtained from sources other than the health kiosk such as from tracking devices or services associated with users.

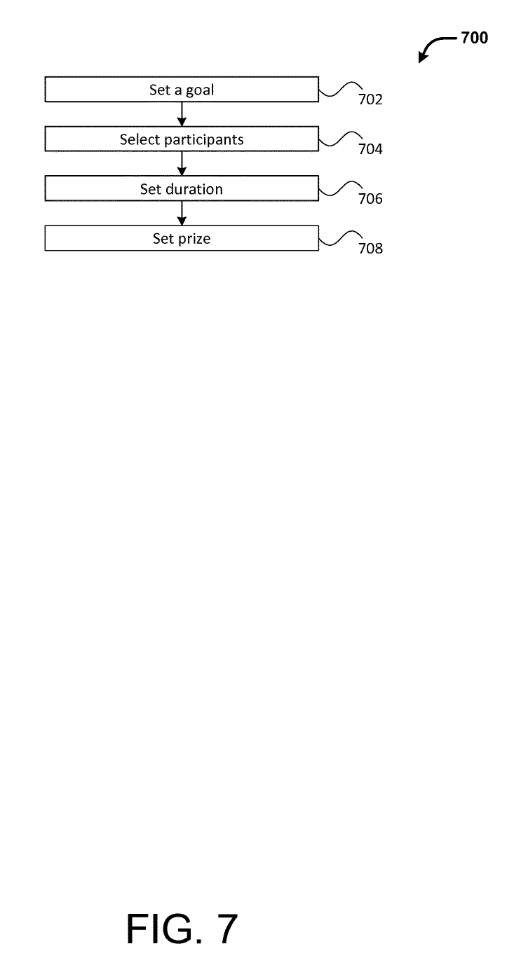

FIG. 7 illustrates an exemplary process 700 for a setting up a challenge program, in accordance with an embodiment. In some embodiments, the process 700 may be used by a sponsor of a health related challenge program. For example, a company may utilize the process 700 to set up a health challenge for its employees. The process 700 may be implemented, for example, by a server 112 discussed in connection with FIG. 1. A user interface may be provided that allows the sponsor to set up the details related to the health related challenge program. In various embodiments, setting up the challenge may involve more or less steps than illustrated here.

As illustrated, the process 700 includes setting up 702 a goal for the challenge program. The goal may be related to fitness activities (e.g., steps taken, miles run, workout completed, distance covered), physical fitness (e.g., blood pressure, weight change) or the like. In some embodiments, a sponsor can also specify one or more acceptable tracking services or devices that may be used by participants of the challenge program to track their data or performance for the challenge. Such tracking services and devices may include those discussed in connection with FIG. 1.

The process 700 can also include selecting 704 one or more participants for the challenge program. For example, a sponsor (e.g., a company) can select a default set of users (e.g., employees) to participate in the challenge. In some embodiments, the challenge program may not include any participants to start with. A participant may be an individual or a team of individuals.

The process 700 can also include setting 706 a duration for the challenge program. The duration information may include a start date (e.g., Nov. 1, 2013) and/or an end date (e.g., Dec. 1, 2013) for the challenge program.

The process 700 can also include setting 708 prizes or rewards for the challenge program. Examples of the prizes or rewards can be tangible (e.g., certificate, coupons, gift cards, cash, products) or intangible (e.g., redeemably reward points, discount, services). For example, the reward may include reward points that are redeemable in exchange for products or services from a predefined set of providers. Other examples of prizes and rewards may include gift cards, lunch with the winner's CEO and the like.

In some embodiments, the sponsor may be allowed to set up rules or criteria related to the challenge program. Such rules may be related to the eligibility of the participation, criteria for earning rewards or winning a competition, rules for redeeming rewards, and the like. For example, the rules may specify that the minimum number and/or frequency of kiosk checkins that participants need to perform in order to earn rewards. As another example, the health kiosk checkins can be required for enrollment or participation. In some examples, the health related data or health scores can be used as criteria for earning rewards or winning the challenge. Such health related data or health scores can include holistic information about one or more participants such as diet, physical/mental fitness, social engagement, and the like.

### EXAMPLE

The following example describes aspects of an exemplary challenge program that may be sponsored by Whole Foods Markets. Join Whole Foods Markets this February for the 2014 Whole Foods Games: a challenge to play a more active role in your personal health and well-being. Check in at Whole Foods higi Stations citywide to verify your vital stats—one component of higi's three-pillar life Score combining body, lifestyle and community data—and earn points that can be redeemed for products and prizes.

How to play—it's easy, convenient and best of all FREE to enter.
Go to WholeFoodsGames.com.
Create an account and join the challenge.
You'll earn points by checking in at our higi stations in local Whole Foods Markets. Connect your favorite activity tracking device or app to start earning points for being active.
The more points you earn, the more opportunity you have to redeem for coupons from Whole Foods as well as be entered to win our Grand Prizes.

How do we attract and keep customers involved:
Large newspaper promotion to blanket the city throughout the month.
Recruitment of local influencers that could include bloggers, radio personality, etc to take the challenge and earn incentives for participation.
Activation of higi and Whole Foods' channels.
Email promotion through Chicago Sun-Times, Whole Foods and higi lists, including reminders to those who to enter to continue to engage.

THE VALUE TO WHOLE FOODS
Requires users to enter a Whole Foods store to check-in.
Provides Whole Foods with an additional wellness platform that is promoted by an active 3rd party voice.
All rewards can be Whole Foods discounts, coupons and/or gift cards.
Allows Whole Foods to promote products of their choice.
Encourages healthy lifestyle choices.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A computer-implemented method for promoting personal health, comprising:
collecting, by a health kiosk, health-related data from a user;
determining, by one or more processors, a status of the user with respect to a challenge program based at least in part on the collected health-related data; and
providing, by the health kiosk, feedback information based at least in part on the determined status.

2. The method of claim 1, wherein the health-related data includes at least weight, blood pressure, pulse rate and body mass.

3. The method of claim 1, wherein the health-related data is collected automatically by the health kiosk.

4. The method of claim 1, wherein the challenge program is team-based.

5. The method of claim 1, wherein the one or more processors operably connected to the health kiosk.

6. The method of claim 1, wherein determining the status includes determining a health score of the user based at least in part on physical data, lifestyle data and social data associated with the user.

7. The method of claim 5, wherein the social data is obtained from one or more social media platforms.

8. The method of claim 1, wherein determining the status includes activating enrollment of the user in the challenge program.

9. The method of claim 1, wherein the feedback information includes at least one of reward information, personalized coaching information, or targeted advertisement.

10. The method of claim 1, wherein determining the status of the user is further based on additional health-related data obtained from one or more user devices associated with the user.

11. The method of claim 10, wherein the one or more user devices include at least one of a wearable device or a mobile phone.

12. A computer system, comprising:
one or more processors; and
memory, including instructions executable by the one or more processors to cause the computer system to at least
collect, at a health kiosk, health-related data from a plurality of users engaged in a challenge program;
determine a status associated with the plurality of the users with respect to the challenge program based at least in part on the health-related data; and
provide feedback information to at least some of the plurality of users based at least in part on the determined status.

13. The computer system of claim 12, wherein the status is further based on additional health-related data provided by user devices associated with at least a subset of the plurality of users.

14. The computer system of claim 12, wherein determining the status includes determining an overall score based at least in part on physical data, lifestyle data and social data associated with the plurality of users.

15. The computer system of claim 14, wherein the social data is obtained from one or more social media platforms.

16. The computer system of claim 12, wherein determining the status includes activating enrollment of at least some of the plurality of users in the challenge program.

17. The computer system of claim 12, wherein determining the status includes determining a standing of a team of users against one or more other teams that participate in the challenge program.

18. One or more non-transitory computer-readable storage media having stored thereon executable instructions that, when executed by one or more processors of a computer system, cause the computer system to at least:
collect, at a health kiosk, health-related data from a user;
determine a status of the user with respect to a challenge program based at least in part on the collected health-related data and social data about the user obtained from one or more social media platforms; and
provide feedback information based at least in part on the determined status.

19. The one or more non-transitory computer-readable storage media of claim 18, wherein determining the status includes determining a health score of the user based at least in part on the health-related data and the social data.

20. The one or more non-transitory computer-readable storage media of claim 18, wherein determining the status includes activating enrollment of the user in the challenge program.
